(19) United States
(12) Patent Application Publication
(10) Pub. No.: US 2004/0246720 A1
(43) Pub. Date: Dec. 9, 2004

(54) Remote control actuated art lamp

(76) Inventor: Craig O. Koski, Placerville, CA (US)

Correspondence Address: Mark C. Jacobs, 3033 El Camino Avenue, Sacramento, CA, 95821, US

(21) Appl. No.: 10/455,462

(22) Filed: Jun. 4, 2003

(51) Int. Cl. F21V 33/00

(52) U.S. Cl. 362/253

(57) ABSTRACT

A lamp for wall mounting above a piece of wall mounted art, having a base connected to a bottom cover to form an enclosed base interior, wherein a remote controller station is disposed, said lamp having an elongated arm mounted normal thereto, with the arm having a swivel mounted shade thereon. A remote coupled to the controller is disposed on the front surface of the housing. At least two bulbs are disposed in suitable sockets inside the housing. An optional reflector can be used behind each bulb set. A remote actuator having an actuator button activates the bulbs in the housing. A master on/off switch is provided in the base.

### FIELD OF THE INVENTION

This invention pertains to a remote-controlled lamp for use with artworks to cast the art in a favorable light.

### BACKGROUND OF THE INVENTION

Patrons of the arts who keep their art in the home or office recognize the need to show-off the art be it an oil, watercolor, etc., or a sculpture of whatever material under flattering light. One problem that is well recognized is that too much light can be detrimental to certain types of art works. The result is, that ofttimes guests at galleries and in homes, never see the art lit as it should be as the art light if present is kept in the off position.

Thus there is a need for an art lamp that can be easily actuated by remote control to enable the occasional visitors to see the art piece in a bath of flattering light. This invention can also be used by galleries to help them to enhance their individual pieces of art. Thus, the invention has widespread appeal.

The invention accordingly comprises the device possessing the features, properties, the selection of components, which are amplified in the following detailed disclosure, and the scope of the application of which will be indicated in the appended claims.

For a fuller understanding of the nature and objects of the invention, reference should be made to the following detailed description, taken in conjunction with the accompanying drawings.

Applicant conducted a patent search and is aware of the following references, none of which anticipates or discloses the invention of this application.

| INVENTOR | PATENT NUMBER | ISSUE DATE |
|---|---|---|
| DAVIS ET AL | 5,526,345 | Jun. 11, 1996 |
| BUIJ ET AL | 5,459,376 | Oct. 17, 1995 |
| BENJAMIN | 3,871,609 | Mar. 18, 1975 |
| BASACCHI | 6,203,175 | Mar. 20, 2001 |
| HAKKARAINEN ET AL | 5,637,964 | Jun. 10, 1997 |

### SUMMARY OF THE INVENTION

This invention is a picture light having at least one bulb therein, preferably wall mountable and capable of casting a flattering light on a piece of art. The unit features at least one bulb selected from among halogens, xenon, or incandescent for clean white bright light. Fluorescent is not preferred due to its color temperature. The lamp is actuated by the use of a handheld infrared or radio frequency remote controller somewhat similar to the handheld unit used for actuation of an automatic garage door. These controllers are available in the marketplace.

It is a first object therefore to provide a remote-controlled art light.

It is a second object to provide a remote-controlled halogen light that can be wall mounted.

It is a third object to provide a lamp that can flatter both paintings and sculpture.

It is fourth object to provide a lamp that can be easily adjusted to throw light at a specific angle.

It is a fifth object to provide a lamp that optionally can be selectively actuated in a room by the use of a specific frequency emission so that one lamp among many can be lit.

Other objects of the invention will in part be obvious and will in part appear hereinafter.

### BRIEF DESCRIPTION OF FIGURES

FIG. 1 is a front perspective view of the remote control art lamp of this invention.

FIG. 2 is a top perspective view thereof.

FIG. 3 is a bottom plan view of a portion of this invention.

FIG. 4 is an underside rear perspective view of this device with the base cover removed.

FIG. 5 is a bottom front perspective view of this device.

FIG. 6 is a top plan view of an end cap for the shade which cap forms a part of this invention.

FIG. 7 is a perspective view of the cap of FIG. 6.

FIG. 8 is a perspective view showing the lamp lens having been partially removed.

FIG. 9 is a bottom view of the exposed light housing.

FIG. 10 is a top perspective view of the lamp housing cover.

FIG. 11 is a perspective view of the handheld remote controller used in this invention.

FIG. 12 is a side elevational view showing the lamp portion of the device mounted on the wall above a picture to be lit up.

### DESCRIPTION OF THE PREFERRED EMBODIMENT

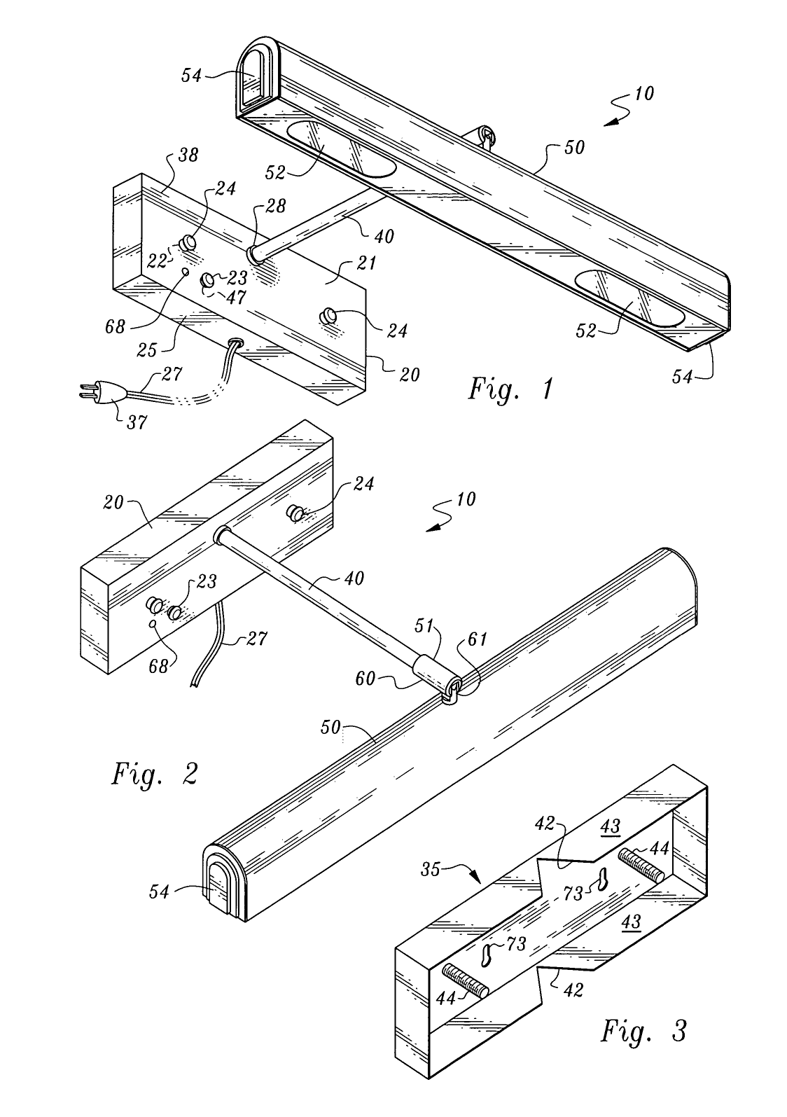

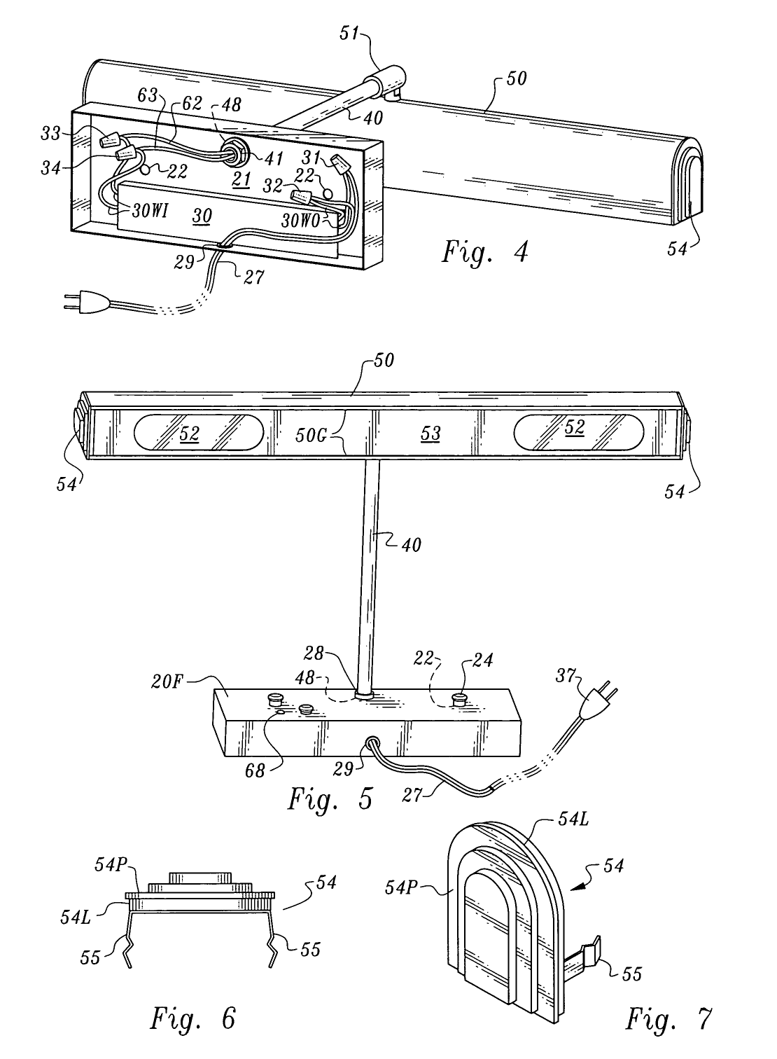

In FIG. 1 there is seen a perspective view of the device 10 of this invention. Lamp 10 has a base 20 comprising a main housing 21, in which there is an opening 22 for a master switch 23. This master switch is a standard pushbutton on/off switch, more about which will be set forth infra. Also seen in FIG. 1 are a pair of spaced decorative stud nuts 26, often of brass. These secure the housing underside 35, seen in FIG. 4 to the main housing 21.

As can be seen the main housing is an open bottom box having spaced parallel side walls disposed normal to spaced front and rear walls. The rear wall 25 has a threaded open centre bolt disposed therein, through which passes the electrical cord 27 for internal connection. Cord 27 terminates in a conventional electrical plug 37.

An arm socket 28 is threaded into the main housing top wall 38 and arm 40 is threadedly engaged thereto at a first end of said arm, preferably distant from the cord entry location. A U-shaped, here tilted, shade 50 is threadedly engaged on the opposite end, which is the second end of the arm 40. Near the arm socket is eye 68 which is used to receive the signal from the remote actuator not seen in this view. This eye is part of the controller disposed within the housing. Such eyes are well known in the art. The term “shade” is an art term to designate the bulb housing. Arm 40 may be of a fixed length or it may be adjustable as by telescoping one element into another and using a conventional locking mechanism to secure one tube with respect to the second tube to fix the adjusted length.

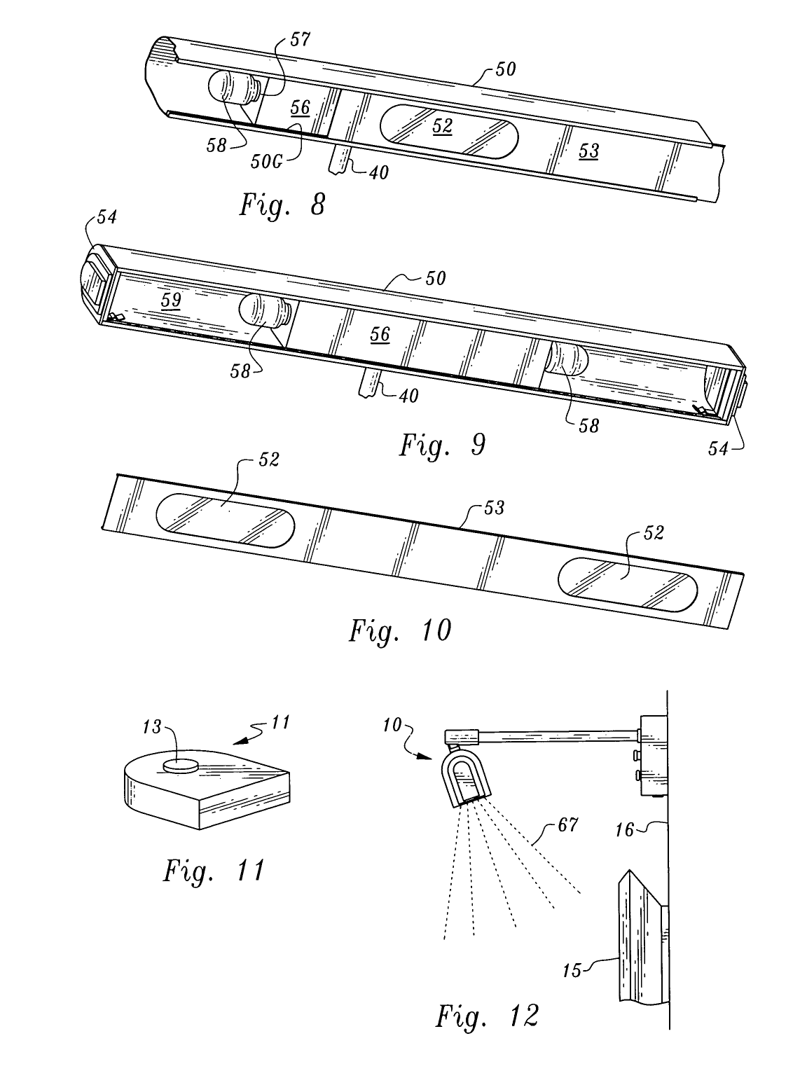

In FIG. 1, lens 52 is shown disposed in its normal operative location across the opening of the shade 50. See infra and the discussion pertaining to FIG. 8. One of the two end caps 54 is also seen in this figure.

Cap nuts 24 are seen spaced apart holding the bottom cover plate 35 which is seen in detail in FIG. 3 in its assembled location. These cap nuts 24 fit over the respective studs 44 per FIG. 3. Upon assembly, these studs 44 are disposed through the spaced apertures 22 shown in FIG. 4, for engagement with the cap nuts 24.

The discussion now moves to FIG. 2. This is a perspective view of the device of this invention. Here the connection of the U-shaped shade 50 to the hollow arm 40 is seen. A conventional ball swivel 51 is seen to be disposed at the upper end of hollow arm 40. Swivel 51 has a receiving section 60 which is preferably threadedly engaged to the upper or second end of the arm 40. A friction fit may also be employed. Receiving section 60 also has a socket usually at the top thereof for the receipt of a ball swivel 61. Ball swivel 61 is threaded to a connector not seen or is soldered or welded or otherwise attached to the shade 50. Both arm 40 and the swivel 51 are hollow such that wiring can pass therethrough to the interior of the shade 50. The wiring will be discussed infra.

In FIG. 3 the housing bottom cover 35 is seen. This is a five sided box having a pair of notches 42, and one in each of the two sidewalls 43 of the bottom cover which nests into base 20. A pair of upstanding threaded studs 44 are suitably disposed to be able to engage the cap nuts 24, shown in FIG. 4 overlying the apertures 22 in the housing, both of which can just be made out in FIG. 4. The spacing between the end walls- unnumbered, and the side walls 43 is slightly smaller than the opening size of the housing 21 to permit a snug function fit prior to the attachment of the cap nuts 29 to the two studs 44. The notches 42 are positioned to permit clearance of the incoming wiring 27 and to grant clearance for the lock nut 41 which holds the arm 40. The lamp is wall mounted by the sliding the two keyhole openings 73 seen in FIG. 3 over two screws disposed in wall anchors, or by using a less preferred picture hook for engaging said keyholes. While two such keyholes are shown, as an alternative, one central key hole may be employed.

In FIG. 4 the underside of the main housing is seen. Cord 27 passes through an internal plastic grommet 29 to the base interior. The cord 27 has two wires, positive and negative. Each of these is connected by conventional wire nuts 31,32 into which have been placed the input wires 30WI of the remote control station 30. The output wires 30WO from the remote control station 30, only one of which is visible in FIG. 4 is also disposed in wire nuts 34 and 33 respectively along with wires 62,63 that are placed through the arm 40's lower end opening for delivery to the interior of the shade. A locknut 41 is seen retaining the arm 40 in its vertical position through the main housing.

In FIG. 5, one of he cap nuts 24 has been purposely removed to reveal the stud 44 seen in FIG. 3 disposed upwardly within the housing 21 and which protrudes slightly through aperture 48 for engagement with the cap nut 24. Wiring 27 which terminates in a conventional plug 37 is dosed through grommet 29 for internal connection to be discussed infra. In this view also, the sensor eye 68 can be seen on the housing front surface.

Also seen in FIG. 5 is the bulb housing 50 previously discussed, and housing cover 53 having the two lenses 52 built in for light transmission. Cover 53 is retained by a pair of opposed grooves SOG at the termini of the generally U-shaped housing 50. Lens 52 may be heat resistant plastic or thermally safe glass while the balance of the cover 53 is metal such as brass or aluminum. The location of the arm socket 28 which is disposed near the top of the housing front surface is seen in aperture 48. The reader is advised that the lamp is mounted to a wall and does not sit on a desk. Thus, what would normally be a top surface is in fact a front surface when considered from the in-use position of the device. As can be seen, arm 40 is threadedly engaged into arm socket 28.

The discussion turns now to FIGS. 6 and 7 which should be viewed together, as they are different views of the same part namely the end cap 54 one of which fits in each end of the U-shaped shade 50. As can be seen in FIG. 6, end cap 54 has an outside periphery 54P of a decorative nature of a generally U-shaped configuration. The end cap has a recessed lower portion or lip 54L that nests inside of the housing, while aspect 54P overlies the edge thereof. The end cap 54 is retained by the force of the two opposed springs 55.

In FIG. 8, one of the two lenses 52 has been removed, from the underside of the cover 53 in order to show the shade interior 56 with one of its socket's 57 having a bulb 58 therein. In FIG. 9, the shiny reflector 59 disposed within the housing 50, one of which is disposed behind each bulb 58 may be seen.

FIG. 10 is plan view of the shade cover 53, the aspects of which have been discussed supra.

As noted earlier, the key to business success to this lamp is the ability of the remote control. Thus the handheld remote actuator 11 has a single actuation button 13, one click of which turns the bulbs on, while a double click returns the bulb(s) off, while retention of finger pressure on button 13 serves to dim or brighten the bulb intensity of all bulbs present. While two are shown, the lamp could also include one to four bulbs or more. If two pairs are employed, they can be set out in two opposed pairs or linearly. Bulbs such as are shown may have a screw in or bayonet or bi-pin base and are available in the marketplace. The remote actuator and the remote station controller disposed within the base of the lamp are off the shelf units available from at least one Asian source. These may use an infra red light, radio frequency (rf) or ultra sound as the actuating signal.

In FIG. 12, lamp 10 is seen to be hanging on the wall 16 in its in use position, wherein it is casting light rays 67 upon art piece 15. The actuation frequency for each remote station also known as the controller 30 can be of a different frequency, if so desired. If a plurality of lamps has the same actuating frequency, then a multiplicity of these can be placed in a home or art gallery and each one can be lit when the user is in the vicinity of that lamp to show-off a particular piece of art.

It is seen that the remote control lamp of this invention that permits the user to set the level of light intensity from afar as the mood suits him or her, or permits full on, full off as may be desired, is a significant improvement and benefit over conventional art mounted or art adjacent lamps.

While the lamp of this invention is seen to have two opposed bulbs with their bases facing toward each other, a similar lamp having only one bulb or up to about four spaced bulbs of bulbs, preferably of a variety offering full spectrum light capability, is within the skill of the art.

While the lamp of this invention has been shown to be an electrical lamp adapted to be plugged into a 110-volt 60 cycle AC wall outlet, no reason is seen why the power source cannot be of a different voltage and amperage.

Since certain changes may be made in the described apparatus without departing from the scope of the invention herein involved, it is intended that all matter contained in the above description and shown in the accompanying drawings shall be interpreted as illustrative and not in a limiting sense.

I claim:

1. A remote controllable wall mountable wall lamp for illuminating art hung on the wall, which comprises:
a main base housing having a front surface, and spaced top and bottom walls and spaced side walls and open at the rear, with a master on/off switch, and a remote actuation controller disposed in said housing, said controller having an eye of said controller disposed through the front surface of said housing;
a rear cover attachable to said main base housing, and having at least one aperture for wall mounting said lamp;
an arm disposed normal to said front surface of said housing and having a shade attached thereto, said shade having at least one bulb therein,
said at least one bulb, said master switch and said remote actuation controller being electrically connected for illumination,
and a handheld remote actuator for communication with said eye to turn said wall mountable lamp on and off, and when on to change the intensity of the light emitted.

2. The wall mountable lamp of claim 1, wherein there are two spaced apertures for mounting the lamp to the wall.

3. The lamp of claim 1, wherein the shade is pivotally attached to the arm of the lamp.

4. The lamp of claim 1, wherein the shade includes at least one removable end cap to provide access to the at least one bulb therein.

5. The lamp of claim 1, wherein the remote actuator operates in a mode selected from the group consisting of infrared, ultrasonic and radio frequency signals to communicate with the remote controller disposed in the lamp base housing.

6. The lamp of claim 1, wherein the rear cover includes a pair of upstanding threaded posts, and the base housing includes a pair of spaced apertures aligned to receive the threaded posts therethrough, whereby the cover may be connected to the base housing by cap nuts disposed over said threaded posts.

7. The lamp of claim 1, wherein the base housing and the arm are made of metal.

8. The lamp of claim 1, wherein the shade has a pair of opposed positioned bulbs.

9. The lamp of claim 1, wherein said arm is comprised of two tubes one of which telescopes within the other, and a locking mechanism to fix the adjusted length.

10. A remote controllable wall mountable wall lamp for illuminating art hung on the wall, which comprises:
a main base housing having a front surface, and spaced top and bottom walls and spaced side walls and open at the rear, with a master on/off switch, and a remote actuation controller disposed in said housing, said controller having an eye of said controller disposed through the front surface of said housing;
a rear cover attachable to said main base housing, and having two spaced apertures for wall mounting said lamp;
an arm disposed normal to said front surface of said housing, wherein said arm is comprised of two tubes one of which telescopes within the other, and a locking mechanism to fix the adjusted length
and a shade pivotally attached to said arm, said shade having at least one bulb therein,
said at least one bulb, said master switch and said remote actuation controller being electrically connected for illumination,
and a handheld remote actuator for communication with said eye to turn said wall mountable lamp on and off, and when on to change the intensity of the light emitted.
